(19) United States
(12) Patent Application Publication
(10) Pub. No.: US 2019/0066904 A1
(43) Pub. Date: Feb. 28, 2019

(54) CHIP-TYPE PASSIVE COMPONENT

(71) Applicant: HUI WEN CHANG, Taoyuan (TW)

(72) Inventor: HUI WEN CHANG, Taoyuan (TW)

(21) Appl. No.: 15/690,446

(22) Filed: Aug. 30, 2017

(51) Int. Cl. H01F 27/28; H01F 27/02; H01F 1/14; H01F 41/04

(52) U.S. Cl. CPC H01F 27/2804; H01F 27/02; H01F 2027/2809; H01F 41/043; H01F 1/14

(57) ABSTRACT

A chip-type passive component includes at least one base, at least two coils, a magnetic cover and at least two silver-palladium layers. Both ends of the base have a flange, and one of the flanges has at least two holes; the at least two coils are wound around the outer end of the base; the magnetic cover is covered onto the exterior of the coil, and both ends of the magnetic cover have an opening, and the flange is latched to the opening; and the at least two silver-palladium layers is formed on both sides of one of the openings of the magnetic cover, and the coil is passed through the hole and contacted with the silver-palladium layer to define an electric connection.

### FIELD OF THE INVENTION

The present invention relates to a chip-type passive component, and more particularly to a closed chip-type passive component with a magnetic flux density in compliance with requirements and applicable for automated production.

### BACKGROUND OF THE INVENTION

Passive components such as inductors or transformers are indispensable components for the operation of different electronic devices, but conventional passive components not just have the shortcoming of a large volume only, but also require a complicated manufacturing process for their manufacture and result in a low yield rate and a high manufacturing cost. In addition, the structure of the conventional passive components also fails to meet the requirements of compact and flat structure of the present electronic devices.

A chip-type passive component as disclosed in R.O.C. Pat. No. M433626 is provided to overcome the aforementioned problem, and such chip-type passive component comprises a wire winding seat, a plurality of coils, a magnetic core, and a base, wherein the base and the wire winding seat are configured substantially into an L-shape, and a wire winding rod is provided for winding each coil, and a flange disposed at both ends of the wire winding rod separately, and the magnetic core and the base are fixed to the two opposite flanges of the wire winding seat respectively, and the base has a plurality of inner electrical contacts and a plurality of outer electrical contacts disposed on two opposite surfaces of the base respectively and communicated with each other, and each coil is electrically coupled to each respective inner electrical contact, and the whole chip-type passive component is mounted onto a circuit board by surface mount technology (SMT) to achieve the compact and flat structural requirements. However, the coils of this patent requires an additional base for soldering, and such manufacturing method not just incurs a higher manufacturing cost and a longer manufacturing time only, but also has the shortcoming of producing a magnetic flux leakage caused by the complicated manufacturing process and an open design without any shielding for magnetic fields, so that the magnetic flux of the whole passive component cannot meet the standard. Therefore, it is a main subject for related designers and manufacturers to design a novel hardware design and overcome the shortcomings of the conventional chip-type passive component having a magnetic flux leakage due to the complicated manufacturing process and no magnetic field shielding.

### SUMMARY OF THE INVENTION

In view of the aforementioned shortcomings of the conventional passive component, the inventor of the present invention based on years of experience in the related industry to conduct extensive research and experiment, and finally developed a chip-type passive component in accordance with the present invention to overcome the shortcomings of the prior art.

Therefore, it is a primary objective of the present invention to provide a closed chip-type passive component capable of providing a magnetic flux density in compliance with the requirements and applicable for automated production and overcome the aforementioned problems by a structure with a magnetic cover wound around the exterior of the coil and a hardware design of a silver-palladium layer and having the advantageous effects of providing a magnetic flux density in compliance with the requirements, simplifying the manufacturing process for automated production, and maintaining a good transmission distance.

To achieve the aforementioned and other objectives, the present invention discloses a chip-type passive component comprising at least one base, at least two coils, a magnetic cover, and at least two silver-palladium layers, characterized in that the at least one base has a flange protruded from both ends of the base separately, and one of the bases has at least two holes formed thereon; the at least two coils are wound around the outer end of the base; the magnetic cover is covered onto the exterior of the coil and has an opening formed at both ends of the magnetic cover, and the flange is latched to the opening; and the at least two silver-palladium layers are formed on both sides of one of the openings of the magnetic cover, and the coil is passed through the hole and contacted with the silver-palladium layer to define an electric connection.

In the aforementioned chip-type passive component, the chip-type passive component has one or two bases.

In the aforementioned chip-type passive component, when the chip-type passive component has two bases, the bases are stacked vertically with respect to each other.

In the aforementioned chip-type passive component, the base is made of zinc.

In the aforementioned chip-type passive component, the flange is made of zinc.

In the aforementioned chip-type passive component, the base has six coils wound around the outer end of the base.

In the aforementioned chip-type passive component, the coil is made of copper.

In the aforementioned chip-type passive component, the magnetic cover is made of nickel.

The aforementioned chip-type passive component further comprises an adhesive layer coated between the magnetic cover and the flange

In the aforementioned chip-type passive component, the silver-palladium layer is formed on both sides of one of the openings of the magnetic cover by electroplating.

In the aforementioned chip-type passive component, both sides of the opening of one of the magnetic covers have six silver-palladium layers formed thereon.

In the aforementioned chip-type passive component, the silver-palladium layer further has a groove concavely formed thereon.

In the aforementioned chip-type passive component, the coil is formed at the groove by soldering.

Therefore, the chip-type passive component of the present invention adopts a structure with a magnetic cover wound around the exterior of the coil and a hardware design of a silver-palladium layer to provide a magnetic flux density in compliance with the requirements and applicable for automated production and the advantageous effects of providing a magnetic flux density in compliance with the requirements, simplifying the manufacturing process for automated production, and maintaining a good transmission distance.

### BRIEF DESCRIPTION OF THE DRAWINGS

FIG. 1 is an exploded view of a chip-type passive component in accordance with a first preferred embodiment of the present invention;

FIG. 2 is a perspective view of a chip-type passive component in accordance with the first preferred embodiment of the present invention;

FIG. 3 is a bottom view of a chip-type passive component in accordance with the first preferred embodiment of the present invention;

FIG. 4 is a schematic view of a magnetic cover in accordance with the first preferred embodiment of the present invention;

FIG. 5 is a perspective view of a chip-type passive component in accordance with a second preferred embodiment of the present invention; and

FIG. 6 is a bottom view of a chip-type passive component in accordance with the second preferred embodiment of the present invention.

### DESCRIPTION OF THE PREFERRED EMBODIMENTS

The technical contents of the present invention will become apparent with the detailed description of preferred embodiments accompanied with the illustration of related drawings as follows. It is intended that the embodiments and figures disclosed herein are to be considered illustrative rather than restrictive.

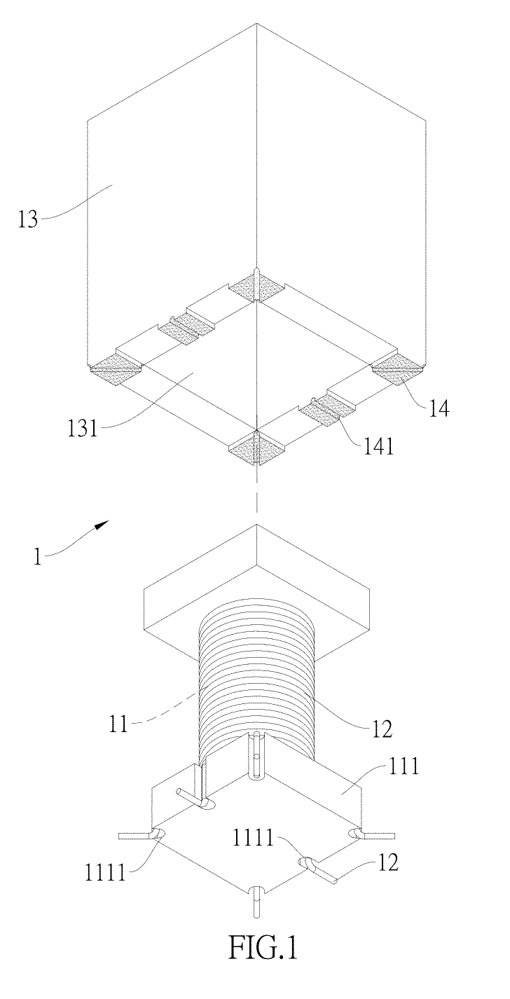

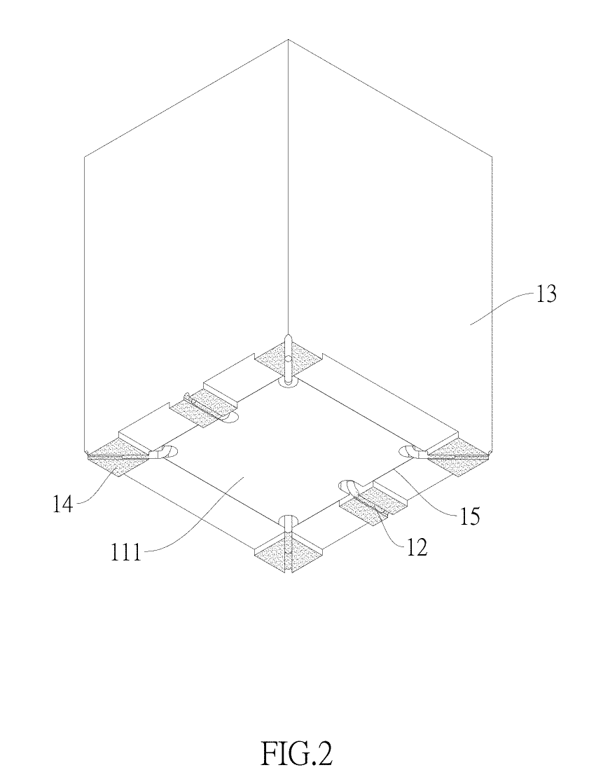

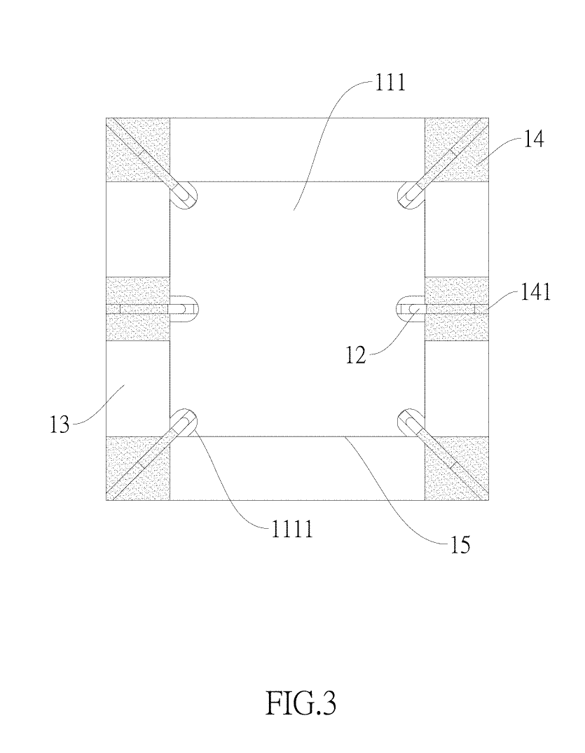

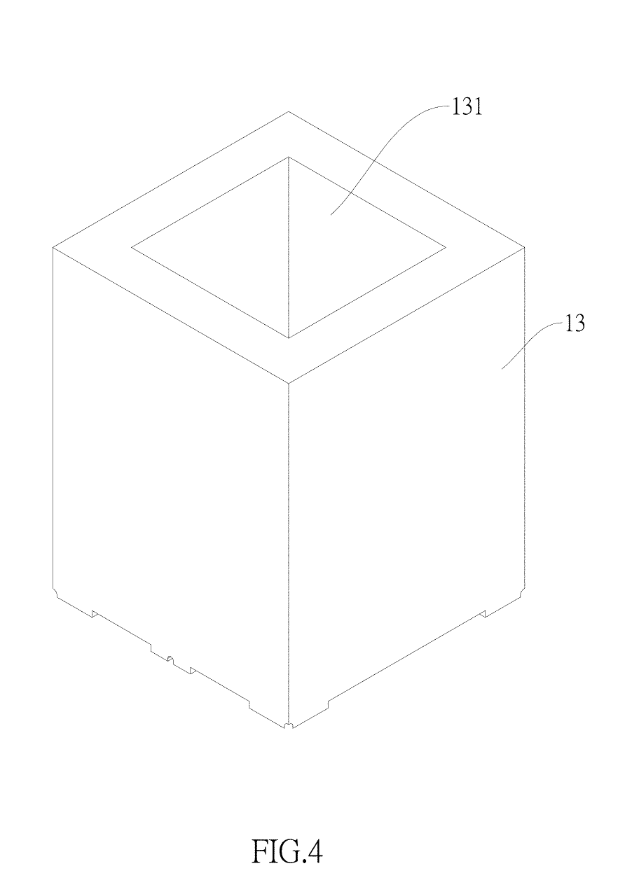

With reference to FIGS. 1 to 4 for the exploded view, perspective view, and bottom view of a chip-type passive component and the schematic view of a magnetic cover in accordance with the first preferred embodiment of the present invention respectively, the chip-type passive component comprises:

at least one base (11), having a flange (111) protruded from both ends of the base (11) separately, and one of the bases (11) having at least two holes (1111) formed thereon, wherein the chip-type passive component (1) may have one or two of the bases (11), and when the chip-type passive component (1) has two bases (11), the bases (11) are stacked vertically with respect to each other, and the base (11) is made of zinc, and the flanges (111) are made of zinc, and the chip-type passive component (1) of a preferred embodiment of the present invention has one base (11) made of zinc, and the base (11) has two flange (111) protruded from both ends of the base (11) respectively and also made of zinc, so that the base (11) and the flange (111) are formed into an H-shape, and one of the flanges (111) has six holes (1111);

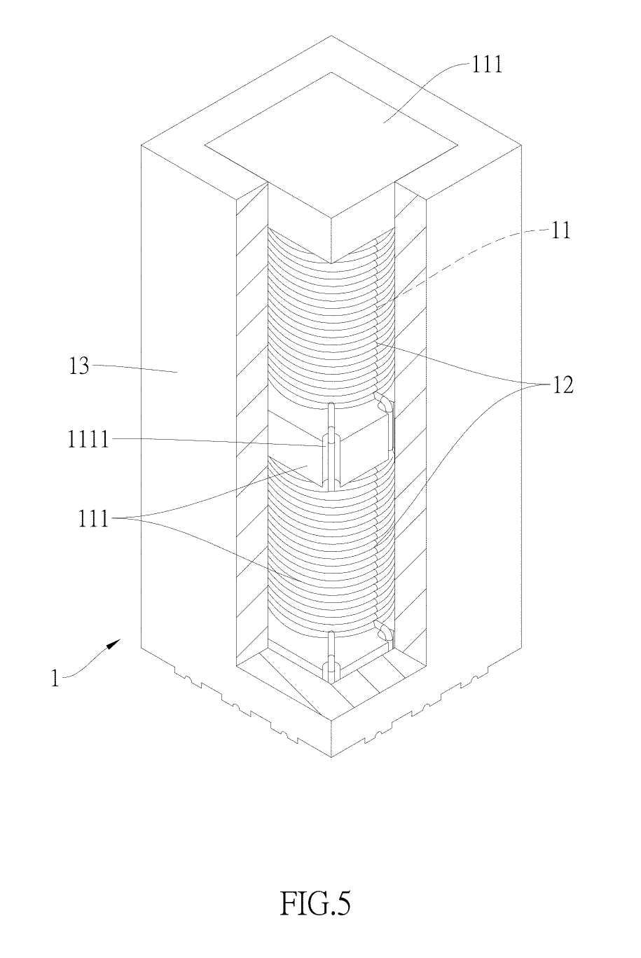

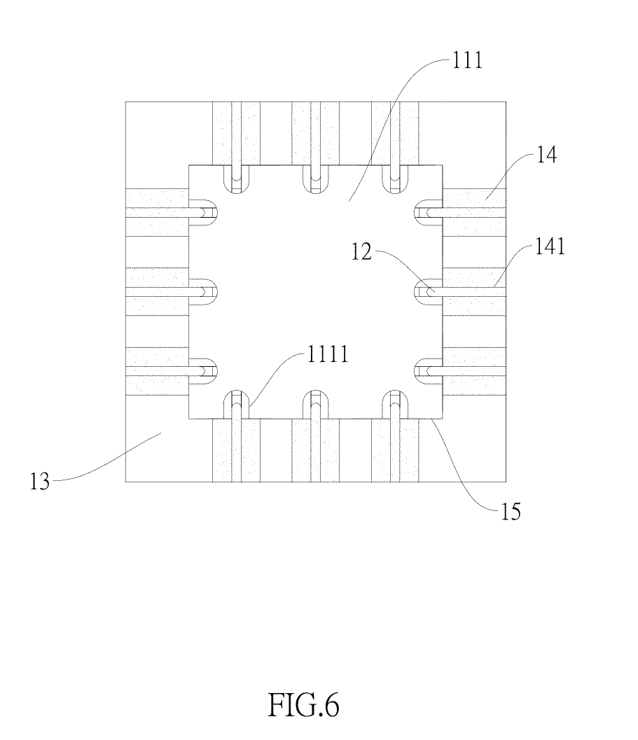

at least two coils (12), wound around the outer end of the base (11); wherein the outer end of the base (11) is wound by six coils (12), and the coils (12) are made of copper, and the six coils (12) in accordance with a preferred embodiment of the present invention is made of copper and wound around the outer end of the base (11), and with reference to FIGS. 5 and 6 for the perspective view and the bottom view of a chip-type passive component in accordance with the second preferred embodiment of the present invention respectively, the chip-type passive component (1) has two bases (11), and the bases (11) are stacked vertically with respect to each other, and the outer end of each base (11) is also wound with six coils (12), so that 12 coils (12) are passed through 12 holes (1111) of the flange (111) respectively; and it is noteworthy that the quantity of coils (12) is used for illustrating the invention, but not intended for limiting the scope of the invention, and persons having ordinary skill in the art may change the quantity of coils (12) according to the requirement without affecting the actual implementation of the invention;

a magnetic cover (13), covered onto the exterior of the coils (12), and having an opening (131) formed at both ends of the magnetic cover (13) separately, wherein the flange (111) is latched to the opening (131); the magnetic cover (13) is made of nickel; an adhesive layer (15) is coated between the magnetic cover (13) and the flange (111), and both ends of the magnetic cover (13) made of nickel have an opening (131) and latched to the flange (111), and the adhesive layer (15) is coated between the magnetic cover (13) and the flange (111) for fixing the magnetic cover (13) and the base (11); and

at least two silver-palladium layers (14), formed on both sides of one of the openings of the magnetic cover (13), wherein the coils (12) are passed through the holes (1111) and contacted with the silver-palladium layer (14) to define an electric connection, and the silver-palladium layer (14) is formed on both sides of one of the opening (131) of the magnetic cover (13) by electroplating, and the magnetic cover (13) has six silver-palladium layers (14) formed on both sides of one of the openings (131), and the silver-palladium layer (14) further has a groove (141) concavely formed thereon; and the coil (12) is formed at the groove (141) by soldering, and six silver-palladium layers (14) in accordance with a preferred embodiment of the present invention are uniformly formed on both sides of one of the opening (131) of the magnetic cover (13) by electroplating, and the silver-palladium layer (14) has a groove (141) concavely formed thereon, and the coil (12) is formed at the groove (141) by soldering to achieve the hardware configuration of the closed chip-type passive component.

To make it easier for the examiner to understand the objectives, technical characteristics and effects of this invention, actual implementations and embodiments are provided for illustrating the scope of applicability of the chip-type passive component of the present invention, but not intended for limiting the scope of the invention. The chip-type passive component (1) may be manufactured according to the present invention, and the structure with the magnetic cover (13) wound around the exterior of the coil (12) and the hardware design of the silver-palladium layer (14) contacted with the coil (12) can overcome the magnetic flux leakage of the conventional chip-type passive component caused by the complicated manufacturing process and no shielding for magnetic fields, so as to achieve the effect of complying with the requirement of the magnetic flux density, simplifying the manufacturing process for automated production, and maintaining a good transmission distance. Firstly, at least one base (11) is prepared, wherein the base (11) has a flange (111) protruded from both ends of the base (11), wherein the base (11) one of the flanges (111) has at least two holes (1111) formed thereon, an then six coils (12) are prepared, wherein the coils (12) are wound around the outer end of the base (11) and then a magnetic cover (13) is prepared, wherein the magnetic cover (13) is covered onto the exterior of the coils (12), and both ends of the magnetic cover (13) have an opening (131) formed thereon, wherein the flange (111) is latched to the respective opening (131), and the adhesive layer (15) is coated between the magnetic cover (13) and the flange (111) for fixing the magnetic cover (13) and the base (11); and finally, six silver-palladium layers (14), wherein the silver-palladium layers (14) are formed on both sides of one of the openings (131) of the magnetic cover (13), wherein the coils (12) are passed through the holes (1111) and contacted with the silver-palladium layers (14) respectively to define an electric connection, and six silver-palladium layers (14) are uniformly formed on both sides of one of the openings (131) of the magnetic cover (13) by electroplating, and the silver-palladium layer (14) has a groove (141) concavely formed thereon, and the coil (12) is formed at the groove (141) by soldering so as to achieve the hardware configuration of the closed chip-type passive component.

In summation of the description above, the chip-type passive component of the present invention has the following advantages over the prior art and conventional products:

The chip-type passive component of the present invention adopts a structure with a magnetic cover wound around the exterior of the coil and a hardware design of a silver-palladium layer to provide a magnetic flux density in compliance with the requirements and applicable for automated production and the advantageous effects of providing a magnetic flux density in compliance with the requirements, simplifying the manufacturing process for automated production, and maintaining a good transmission distance.

What is claimed is:

1. A chip-type passive component, comprising:
at least one base, having a flange protruded from both ends of the base separately, and one of the bases having at least two holes formed thereon;
at least two coils, wound around the outer end of the base;
a magnetic cover, covered onto the exterior of the coil, and having an opening formed at both ends of the magnetic cover, and the flange being latched to the opening; and
at least two silver-palladium layers, formed on both sides of one of the openings of the magnetic cover, and the coil being passed through the hole and contacted with the silver-palladium layer to define an electric connection.

2. The chip-type passive component of claim 1, wherein the chip-type passive component has one or two of the bases.

3. The chip-type passive component of claim 2, wherein when the chip-type passive component has two bases, the bases are stacked vertically with respect to one another.

4. The chip-type passive component of claim 2, wherein the base is made of zinc.

5. The chip-type passive component of claim 1, wherein the flange is made of zinc.

6. The chip-type passive component of claim 1, wherein the base has six coils wound around the outer end of the base.

7. The chip-type passive component of claim 6, wherein the coil is made of copper.

8. The chip-type passive component of claim 1, wherein the magnetic cover is made of nickel.

9. The chip-type passive component of claim 1, further comprising an adhesive layer coated between the magnetic cover and the flange.

10. The chip-type passive component of claim 1, wherein the silver-palladium layer is formed on both sides of one of the openings of the magnetic cover by electroplating.

11. The chip-type passive component of claim 1, wherein both sides of the opening of one of the magnetic covers have six silver-palladium layers formed thereon.

12. The chip-type passive component of claim 11, wherein the silver-palladium layer further has a groove concavely formed thereon.

13. The chip-type passive component of claim 1, wherein the coil is formed at the groove by soldering.

14. The chip-type passive component of claim 12, wherein the coil is formed at the groove by soldering.
